(19) United States
(12) Patent Application Publication
(10) Pub. No.: US 2015/0159426 A1
(43) Pub. Date: Jun. 11, 2015

(54) CONCEALMENT CAVITY IN A DOOR

(71) Applicant: Charles Jared Kallay, Painesville, OH (US)

(72) Inventor: Charles Jared Kallay, Painesville, OH (US)

(21) Appl. No.: 14/374,295

(22) PCT Filed: Jun. 4, 2012
(86) PCT No.: PCT/US12/40696

§ 371 Date: Feb. 19, 2015

(51) Int. Cl. E06B 5/11; E05G 1/02; E06B 7/28

(52) U.S. Cl. CPC E06B 5/11; E06B 7/28; E05G 1/02

(57) ABSTRACT

A door (10) having one or more concealment cavities (11) and method of accessing the concealment cavitites. The door (10) includes a frame (16) having top and bottom parallel rails (18a, 18b), and first and second spaced parallel stiles (20a, 20b). The frame (16) further includes one or more door panels (26) secured between the top and bottom parallel rails (18a, 18b), and first and second spaced parallel stiles (20a, 20b). At least one concealment cavity (11) is provided in the frame (16) so that the at least one concealment cavity is not noticeable. The concealment cavities (11) can be accessed by opening the door (10) or moving or removing one or more of the door panels (26).

### TECHNICAL FIELD OF THE INVENTION

The present invention relates generally to a concealment cavity in a door. More specifically, the present invention relates to at least one concealment cavity in a frame whereby the concealment cavity is not noticeable.

### BACKGROUND OF THE INVENTION

It is commonly known that man has developed numerous devices and methods for securing valuables from theft. When a dwelling or other structure is burglarized, the most likely targets of theft are those having relatively small size and weight, but high monetary value. For obvious reasons, a thief is more inclined to take jewelry, flatware or other items of sterling or other precious metals, cash, etc., in favor of larger and heavier items which are more difficult to transport and conceal. It is a common practise for burglars to empty and search through the contents of drawers, shelves and other compartments of furniture as a location is burglarized.

One common device for securing valuables is a safe. Most known safes have a key lock or combination lock on a door that provides access to an interior cavity that may be used to store valuables. One problem with safes is the lock mechanism may easily be defeated by a skilled thief. Safes or vaults which are logically expected to contain valuable items are opened by any of a number of means. In fact, skilled thieves can usually defeat a combination lock on most home safes by drilling in as little as twenty minutes or less. For these thieves, the valuables in a safe may be stolen by searching for a safe, and once located, by defeating the safe's locking mechanism, to access its valuable contents. Thus, there exists a need for means to conceal small, valuable items in locations which are not normally discernable to a potential thief.

### SUMMARY OF THE INVENTION

According to an embodiment of the present invention, at least one concealment cavity is provided in a door. The door can include a frame including top and bottom parallel rails, and first and second spaced parallel stiles. The frame further includes a panel secured between the top and bottom parallel rails, and first and second spaced parallel stiles. At least one concealment cavity is provided in the frame whereby it is not noticeable.

According to another embodiment of the present invention, a flush door has a front surface, a rear surface, top and bottom sides and two parallel sides. One or more concealment cavities are mounted into the door such that the concealment cavities are open to the top and bottom sides and to the two parallel sides whereby the at least one concealment cavity is not noticeable. Also, lids can be provided to close the one or more concealment cavities.

According to another embodiment of the present invention, a method of providing at least one concealment cavity in a door includes providing a frame having top and bottom parallel rails, and first and second spaced parallel stiles. The method also includes securing a panel between the top and bottom parallel rails, and first and second spaced parallel stiles. The method further includes providing the at least one concealment cavity in the frame whereby it is not noticeable.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front, three-dimensional view of a door having a plurality of concealment cavities therein, in accordance with the present invention.

FIG. 2 is partial, front, three-dimensional view of concealment cavities disposed in the upper surface of the top rail of a door, in accordance with the present invention.

FIG. 3 is front, three-dimensional view of a door panel incorporating a concealment cavity, in accordance with the present invention.

FIG. 4 is a front, three-dimensional view of the rotating panels containing the concealment cavities in the door of FIG. 1, in accordance with the present invention.

FIG. 5 is front, three-dimensional view of a safe fabricated to fit inside a concealment cavity within a door, in accordance with the present invention.

FIG. 6 is front, three-dimensional view of a flush door incorporating a concealment cavity, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

FIG. 1 is a front, three-dimensional view of a door 10 having one or more hidden compartments or concealment cavities 11 disposed therein. In general terms, concealment cavities 11 provide a user with a concealment area or areas within the boundaries of a door 10, which can be an interior or exterior door, for storage of valuables or items meant to be hidden. Door 10 can be used in both residential and commercial settings, and is not limited to any one design, style, material, hardware, or mechanism.

The concealment cavities 11 within a standard door or slab of any appropriate measurements, such as for example, 1 meter×2 meters, are hidden so as not to change the appearance of the door. It is within the terms of the invention for the door to be of any desired size. The door 10 forms a plane. Door 10 has a plurality of hinges 12, and operates as any standard door, such as by utilizing doorknob 14. The construction of door 10 is not limited to any particular type of material or specific design. The door 10 includes a frame 16 with top and bottom parallel rails 18a and 18b and spaced parallel stiles 20a and 20b. While a plurality of panels 26a, 26b, 26c, 26d, 26e, 26f (26a-26f) are disposed in the door between the top and bottom parallel rails 18a and 18b and the spaced parallel stiles 20a and 20b, it is within the terms of an embodiment to use only a single panel 26. The one or more concealment cavities 11 provided in the frame 16 and/or panels 26a-26f are designed such that they are not noticeable, even when the door is open. The one or more concealment cavities 11 may be removably or permanently built into door, and/or retrofitted into an existing door.

Although door 10 is illustrated with two parallel midrails 22a and 22b, and three vertically disposed midstiles 24a, 24b, and 24c (24a-24c), it is within the terms of the present invention to use any combination of midrails and midstiles for the preferred embodiment. One or more panels 26a-26f are secured between the top and bottom parallel rails 18a and 18b, and spaced parallel stiles 20a and 20b. As show in FIG. 1, an exemplary door construction includes panels 26a and 26b located between top rail 18a and parallel midrail 22a, panels 26c and 26d located between parallel midrail 22a and parallel midrail 22b, and panels 26e and 26f located between parallel midrail 22b and bottom rail 18b.

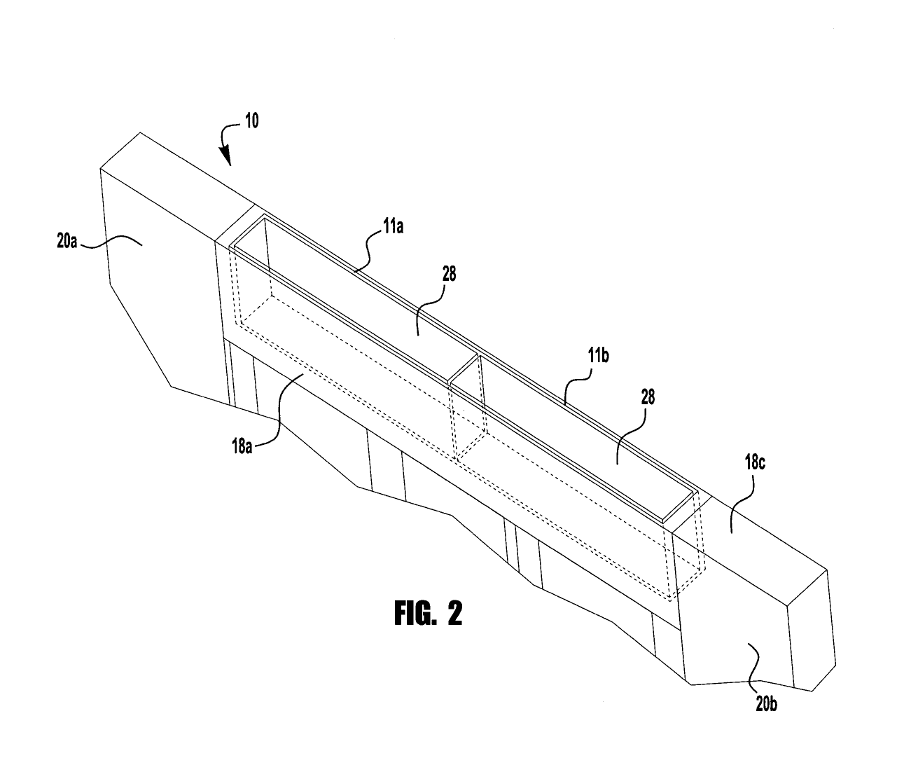

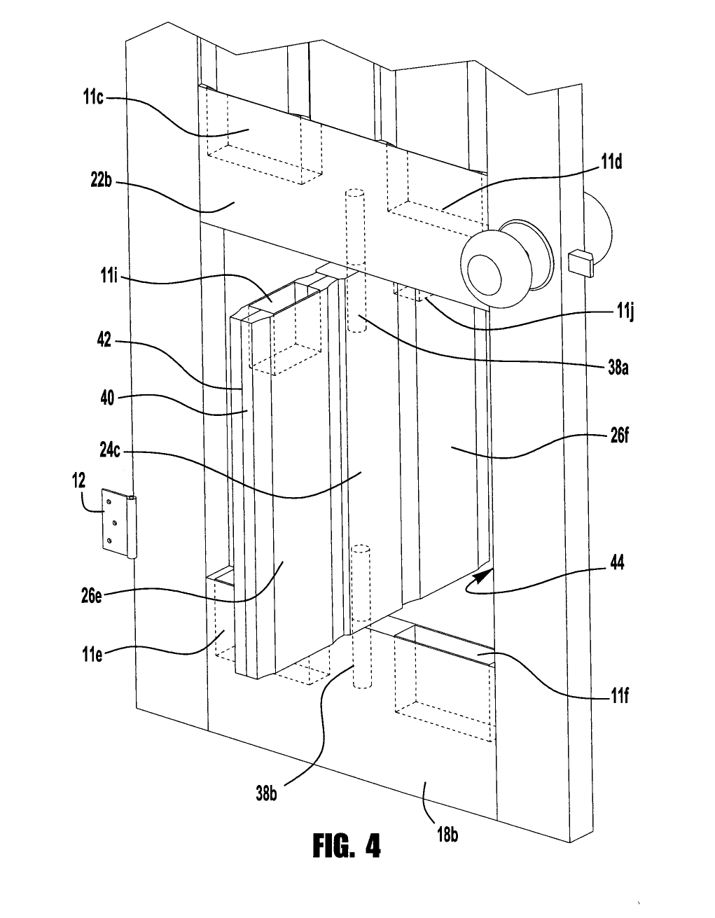

The concealment cavities 11 are generally a hollowing in the door 10 that allows for the storage of valuables or items meant to be hidden. The concealment cavities 11 are disposed in various locations within door 10 so that they are not readily seen or recognized by someone that doesn't know the door contains the concealment cavities. The concealment cavities may be placed in any of a number of locations, such as within top and/or bottom parallel rails 18a and 18b, either of the midrails 22a or 22b, either of the parallel stiles 20a and 20b, in any of the midstiles 24a-24c, in any of the panels 26a-26f, or the hardware of the door 10, such as below the hinges, so that they are not easily visible. Preferably, during the construction of the door 10, the concealment cavities 11 are arranged in one or more desired locations. Concealment cavities 11 may be fitted with an open container 28 or with a closed container 29 having a pivoted lock top 31 to provide additional security, as shown in FIG. 5. The open container 28 and closed container 29 can be constructed of any desired material such as metal or tough plastic.

As shown in FIG. 1, a number of different mechanisms may be used to access concealment cavities 11. For example, concealment cavities 11a and 11b can be placed in the upper surface of top rail 18a. Concealment cavities 11c and 11d can be placed in the upper surface of midrail 22b. Still other concealment cavities 11e and 11f can be placed in the upper surface of bottom rail 18b. In a preferred embodiment, concealment cavities can also be incorporated within the panels 26a-26f, such as concealment cavities 11g and 11h in panels 26c and 26d, respectively. Each of the concealment cavities are similar in that they can not readily be seen or accessed by a person that does not know they are in the door.

Referring to FIG. 2, two exemplary concealment cavities 11a and 11b, which may store individual items, extend down into the top surface 18c of rail 18a. As illustrated, each of the concealment cavities 11a and 11b may be fitted with an open container 28 or with a closed container 29 having a pivoted lock top 31 to provide additional security, as shown in FIG. 5.

As illustrated, there is no closure to the open containers 28 disposed in concealment cavities 11a and 11b, an individual may easily access the items stored therein. Because the concealment cavities 11a and 11b open to the top surface 18c of top rail 18a, the cavities are not visible either when the door 10 is closed or even when the door 10 is open. However, it is within the terms of the invention that there be lids atop open containers 28.

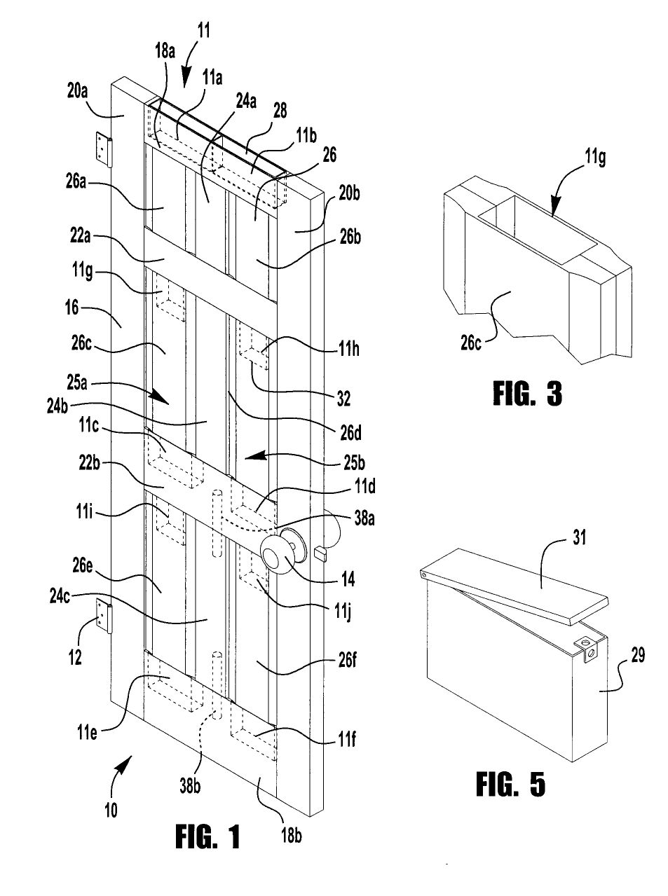

As shown in FIG. 1, the panels 26, such as panels 26c and 26d can include concealment cavities 11g and 11h, respectively. Referring to FIG. 3, there is illustrated an enlarged view of concealment cavity 11g within the panel 26c. As discussed before, an open or closed container can be disposed in the cavities 11g and 11h (not shown). The panels 26c and 26d can be permanently sealed within the openings 25a and 25b between midrails 22a and 22b, stile 20a and midstile 24b and between midstile 24b and stile 20b, respectively, and only accessed by deconstructing the panels from the door. Alternatively, it is within the terms of a preferred embodiment that the concealment cavities, i.e., 11g and 11h, be accessed in a different manner, such as by securing the panels 26c and 26d in the openings 25a and 25b within the door 10 using a frame (not shown) around the front and back of the panel and then simply removing the frame to remove the panel and gain access to the concealment cavity hidden within the panel.

FIG. 4 illustrates another mechanism for accessing concealed cavities within panels, such as concealed cavities 11i and 11j in panels 26e and 26f, respectively. Panels 26e and 26f are adjoined to each other by the midstile 24c. However, panels 26e and 26f are not attached to parallel stiles 20a and 20b although it appears that they are mounted in the door like panels 26c and 26d. In addition, concealed cavities 11e and 11f can be disposed in rail 18b. In this way, neither the concealed cavities 11i and 11j in panels 26e and 26f nor the concealed cavities 11e and 11f are visible to an observer.

The concealed cavities 11e and 11f and the concealed cavities 11i and 11j can be accessed by pivoting the midstile 24c about pivot rods 38a and 38b. Pivot rod 38a extends from midrail 22b into the midstile 24c. Pivot rod 38b extends from bottom rail 18b into midstile 24c. The midstile 24c is attached to the pivot rods 38a and 38b so that the midstile can pivot as shown in FIG. 4 so that the concealed cavities 11e and 11f and 11i and 11j can be accessed. Then, when the midstile 24c is moved back into place, the concealed cavities 11e and 11f and 11i and 11j are again hidden from view.

There are a variety of possible ways to control the movement of the midstile 24c. One such way includes adding a magnetic locking mechanism 40, such as for example a magnetic strip fastened along the edge 42 of panel 26e that engages a magnetic strip 44 secured along spaced parallel stile 20b. When an individual exerts enough force upon either panel 26e or 26f, the magnetic connection between the magnetic strips is broken, and panels 26e and 26f are free to swivel to an open position about pivot rods 38a and 38b. While a pivot connection is shown with panels 26e and 26f, it is within the terms of the preferred embodiments to provide pivotable connections between panels 26c and 26d and the parallel midrails 22a and 22b.

FIG. 5 illustrates a metal safe 29 fabricated to fit inside any of the concealed cavities 11. It is within the terms of the invention that safe 29 is removable from the concealed cavities 11, or permanently integrated into the door during construction. Safe 29 can add an extra layer of security, as it may be lockable, accessible either with a key or with a numeric combination (not shown).

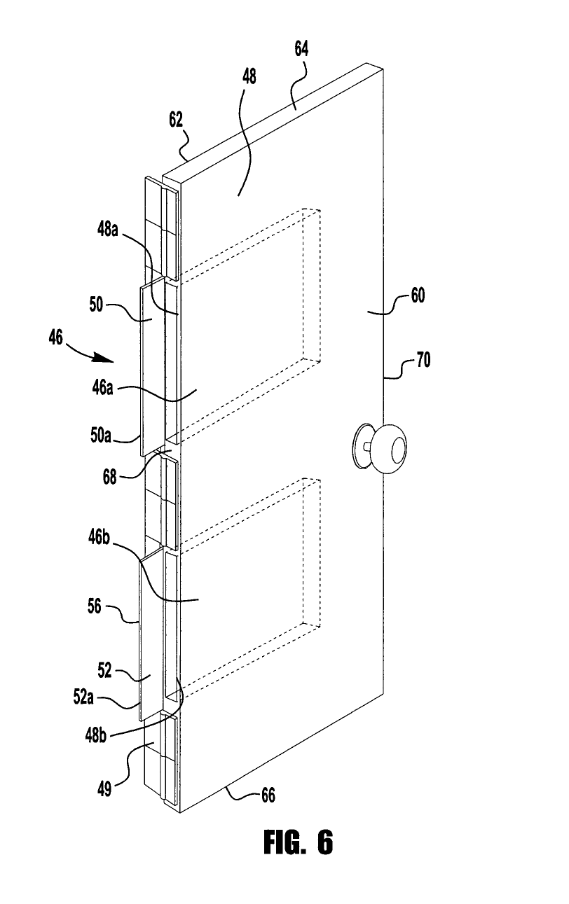

FIG. 6 illustrates an alternative embodiment of a door 48 having one or more concealment cavities 46. As illustrated, door 48 is a flush door that may either be for interior or exterior use.

Flush door 48 could be residential or commercial with no stiles or rails, and may either be hollow or solid. Flush door 48 includes a front surface 60, a rear surface 62, top and bottom sides 64, 66 and two parallel sides 68, 70. As illustrated, there are two concealment cavities 46a and 46b which, if desired, may be fitted with an open container 28, as in FIG. 2, or with a closed container 29 having a pivoted lock top 31, as seen in FIG. 5, to provide additional security. As seen in FIG. 6, there is a hinge 49 secured to side 68 to attach the door 48. The hinge 49 includes two sections 50 and 52 which form lids to close the concealment cavities 46a and 46b, respectively. The lids 50 and 52 may be sealed in a variety of ways, such as having magnetic strips alongs edges 50a and 52a that correspond with matching magnetic stips 48a and 48b along door 48.

According to an embodiment of the invention, a method of providing a concealment cavity 11 in a door 10. This method includes providing the door 10 with a frame 16 including top and bottom parallel rails 18a and 18b, and first and second spaced parallel stiles 20a and 20b; securing a panel 26 between the top and bottom parallel rails 18a and 18b, and first and second spaced parallel stiles 20a and 20b; and providing at least one concealment cavity 11 in the frame 16 whereby it is not noticeable.

The method also includes: disposing the at least one concealment cavity 11 in the bottom rail 18b of a door 10 and/or in the top rail 18a; disposing the at least one concealment cavity 11 in the panel 26; and disposing the at least one concealment cavity 11 in the midrail 22a between the first and second stiles 20a and 20b.

The method further includes: providing a midrail 22b between the first and second stiles 20a and 20b, and disposing first and second panels 26c and 26d between the midrail and the top rail 18a, and disposing third and fourth panels 26e and 26f each secured along a first side to a midstile 24c between the midrail and the bottom rail 18b. The method further includes pivoting the midstile 24c so the third and fourth panels 26e and 26f are out of the plane of the door 10 to allow access to concealment cavities in the group consisting of concealment cavities 11e and 11f in the bottom rail 18b and concealment cavities 11i and 11j in the third and fourth panels.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A door, comprising:
a frame including top and bottom parallel rails, and first and second spaced parallel stiles;
the frame further including a panel secured between the top and bottom parallel rails, and first and second spaced parallel stiles; and
at least one concealment cavity provided in the frame whereby the at least one concealment cavity is not noticeable.

2. The door of claim 1, wherein the at least one concealment cavity is in the bottom rail.

3. The door of claim 1, wherein the at least one concealment cavity is in the top rail.

4. The door of claim 1, wherein the at least one concealment cavity is in the panel.

5. The door of claim 1, wherein the at least one concealment cavity is in a midrail between the first and second spaced parallel stiles.

6. The door of claim 1, wherein one or more of the plurality of concealment cavities include a container disposed within the one or more plurality of concealment cavities.

7. The door of claim 1, further comprising:
a midrail between the first and spaced parallel second stiles;
wherein the panel includes first and second panels disposed between the midrail and the top rail, and third and fourth panels disposed between the midrail and the bottom rail; and
wherein the at least one concealment cavity includes a cavity in each of the first and second panels.

8. The door of claim 7, wherein:
the door forms a plane that includes a first midstile disposed between the top rail and the midrail and a second midstile disposed between the bottom rail and the midrail.

9. The door of claim 8, wherein:
the first and second panels are disposed between the first midstile and the first and second spaced parallel stiles, respectively, and the third and fourth panels are attached to the second midstile.

10. The door (10) of claim 9, wherein the second midstile pivots so the third and fourth panels are out of the plane of the door to allow access to concealment cavities in the group consisting of concealment cavities in the bottom rail and concealment cavities in the third and fourth panels.

11. The door of claim 10, further including a first pivot rod disposed between the midstile and the midrail and a second pivot rod disposed between the midstile and the bottom rail.

12. The door of claim 11, further including a magnetic locking mechanism disposed between the third panel and the first parallel stile.

13. The door of claim 7, further including:
the first panel being secured between the first midstile and the first stile, and the second panel being connected between the first midstile and the second stile; and
the first and second panels being removably secured to the door whereby the concealment cavities are accessible.

14. A flush door, comprising:
a front surface, a rear surface, top and bottom sides and two parallel sides;
one or more concealment cavities mounted into the door such that the concealment cavities are open to the top and bottom sides and two parallel sides whereby the at least one concealment cavity is not noticeable; and
lids closing the one or more concealment cavities.

15. A method of accessing a concealment cavity in a door, including:
providing a frame including top and bottom parallel rails, and first and second spaced parallel stiles;
securing a panel between the top and bottom parallel rails, and first and second spaced parallel stiles; and
providing at least one concealment cavity in the frame whereby the at least one concealment cavity is not noticeable.

16. The method of claim 15, including disposing the at least one concealment cavity in the bottom rail.

17. The method of claim 15, including disposing the at least one concealment cavity in the top rail.

18. The method of claim 15, including disposing the at least one concealment cavity in the panel.

19. The method of claim 15, including disposing the at least one concealment cavity in a midrail between the first and second spaced parallel stiles.

20. The method of claim 15, further including;
removably securing the first panel between the first midstile and the first stile, and removably securing the second panel between the first midstile and the second stile whereby at least one of the the concealment cavities is accessible when at least one of the first and second panels is removed.

21. The method of claim 20, further including pivoting the third and fourth panels to allow access to concealment cavities in the group consisting of concealment cavities in the bottom rail and in the third and fourth panels.
